(19) United States
(12) Patent Application Publication
(10) Pub. No.: US 2009/0321609 A1
(43) Pub. Date: Dec. 31, 2009

(54) Portable Electronics

(76) Inventors: Weigang WANG, Shenzhen (CN); Guangtao XU, Shenzhen (CN); Weiwei CHEN, Shenzhen (CN)

Correspondence Address: MORGAN, LEWIS & BOCKIUS, LLP. (PA), 2 PALO ALTO SQUARE, 3000 EL CAMINO REAL, SUITE 700, PALO ALTO, CA, 94306, US

(21) Appl. No.: 12/482,384

(22) Filed: Jun. 10, 2009

(30) Foreign Application Priority Data
Jun. 27, 2008 (CN) 200820126524.5

(51) Int. Cl. F16M 11/38

(52) U.S. Cl. 248/685

(57) ABSTRACT

A portable electronics comprises a main body and a supporting device, and the supporting device is rotatably connected to the main body wherein, the portable electronics further comprises an automatic opening device, which enables the supporting device to rotate automatically to a position to form an angle between the supporting device and the main body. The portable electronics can automatically open the supporting device and ensure the supporting device to keep a stable angle to the main body after flicking, which makes it convenient for the user to use.

### CROSS-REFERENCE TO RELATED APPLICATION

This application claims priority to and benefit of Chinese Patent Application Serial No. 200820126524.5, filed in the State Intellectual Property Office of the P.R. China on Jun. 27, 2008, the entire contents of which are incorporated herein by reference.

### BACKGROUND OF THE INVENTION

1. Field of the Invention

The present invention relates to a portable electronics.

2. Background of the Related Art

In the current society, various kinds of portable electronics are widely shown in the market and in people's lives. They are not limited to one single function. For example, mobile phones are no longer simple communication tools; with the development of communication technology, mobile phones nowadays have many functions such as entertainment and business functions, which make people's lives more convenient, and improve living standards and working qualities. At present, portable electronics such as mobile phones and Personal Digital Assistants (PDA) have many functions such as taking photos, playing videos, video communication, etc.

However, current portable electronics can not hold the position and positioning status when performing voice/video communication or video playing. The user has to hold the electronics by hand and keep it in a standing position. Thus this is inconvenient for the user.

A Chinese patent CN2935654Y discloses a kind of mobile phone with a supporting structure, comprising a main body and a supporting structure. Both the main body and the supporting structure have a connecting part, which can make the main body connected to the supporting structure. When the mobile phone stands, the supporting structure can outspread with the fulcrum of the connecting part to form an angle with the main body, thus to achieve standing. However, the supporting structure of this mobile phone can be opened to a position only by hand, and can not be opened automatically. After the supporting structure of this mobile phone has been used for a period of time, the connecting part between the supporting structure and the main body gets loose easily, and the supporting structure will probably rotate with the fulcrum of the connecting part Thus it can no longer keep a stable angle to make the mobile phone stand steadily, or it can no longer close tightly to the casing back and may open any time to cause inconvenience.

### SUMMARY OF THE INVENTION

The present invention provides a portable electronics which can automatically open the supporting structure.

The portable electronics provided in the present invention comprises a main body and a supporting device, said supporting device can be rotatably connected to said main body; wherein, said portable electronics further comprises an automatic opening device, which enables the supporting device to rotate automatically to a position to form an angle steadily between said supporting device and said main body.

Because the portable electronics provided in the present invention employs the automatic opening device, the connection between the main body and the supporting device is rotatable and can be opened automatically. The portable electronics does not need manual work to open the supporting device. Instead, the supporting device can be opened automatically to a position with an angle, which is more convenient for the user. Thus it ensures the supporting device to keep a stable angle to the main body after opening to make the mobile phone stand steadily. It also ensures the supporting device to combine tightly to the main body when closing, which improves the durability and convenience of the supporting device of the portable electronics.

### BRIEF DESCRIPTION OF THE DRAWINGS

The foregoing and other features and the advantages of the invention will be better understood from the following detailed description of the preferred embodiments of this invention when taken conjunction with the accompanying drawings in which:

FIG. 1 is a stereogram of the supporting device while closed for the portable electronics provided in the present invention.

FIG. 2 is a stereogram of the supporting device while opened for the portable electronics provided in the present invention.

FIG. 3 is a front view of the internal structure for the portable electronics while the front casing of the main body is removed in one embodiment.

FIG. 4 is a stereogram of the internal structure for the portable electronics while the front casing of the main body is removed in one embodiment.

FIG. 5 is a stereogram of the internal structure for the portable electronics while the front casing of the main body is removed in another embodiment.

FIG. 6 is a front view of the internal structure for the portable electronics while the front casing of the main body is removed in another embodiment.

FIG. 7 is a perspective of the automatic opening device for the portable electronics of another embodiment.

### DETAILED DESCRIPTION OF THE PREFERRED

The aforementioned features and the advantages of the invention as well as the additional features and the advantages thereof will be further explained in the detailed description of the following embodiments when taken conjunction with the drawings.

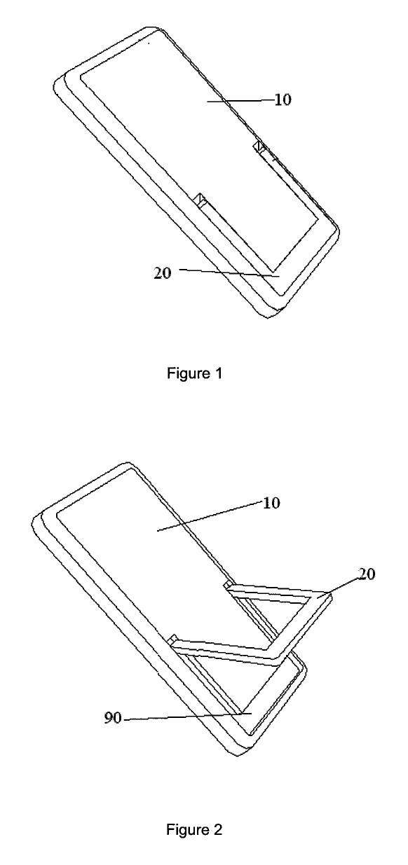

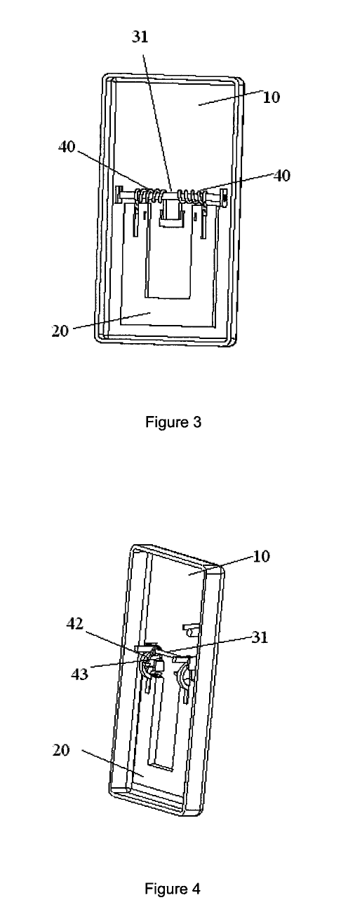

FIGS. 1 and 2 are stereograms of the supporting device for the portable electronics of one embodiment in the present invention while it is closed and opened, respectively. Referring to FIGS. 1 and 2, the portable electronics provided in the present invention comprises a main body 10 and a supporting device 20, the supporting device can be rotatably connected to the main body; the portable electronics further comprises an automatic opening device (not shown in FIGS. 1 and 2), which is configured to cause the supporting device 20 to rotate automatically relative to the main body 10 to a position so as to form an angle steadily between the supporting device and the main body.

The range of said angle is about 30 to 90 degree in some embodiment, which is convenient for up standing or side standing. The angle can be fixed, i.e., the supporting device is automatically opened to the same angle each time. The angle can also be variable, i.e., the supporting device is opened to a different angle each time according to the user's needs.

The setting of abovementioned angles can be achieved by various kinds of caging devices known by one skilled in the art. For example, as shown in FIGS. 1 and 2, setting a predetermined angle between the main body 10 and the supporting device 20, when the supporting device 20 rotates to this angle, two inclined planes get contact with each other to stop further rotation of the supporting device 20. In some embodiment, the caging device can be a rope, a folded connecting rod, etc.

The main body 10 may be various structures, such as straight board, turnover cover, sliding cover, spiral cover, etc. It can also employ various materials, such as metal, plastic, resin, etc. All these factors will not affect the technology scheme implementation of the present invention.

In some embodiment, one side of the main body 10 further comprises a display screen; wherein the supporting device 20 is connected to the main body 10 at the side opposite to the display screen.

Said supporting device 20 can be one or more supporting slabs or hollow stents. The shape of the said supporting device 20 is not limited. However, the basic requirement is that it can support the main body 10, for example a quadrilateral hollow stent. In some embodiment, one side of the main body 10 connected to the supporting device 20 can be configured with a groove 90, wherein the size and shape of the groove match to the supporting device 20. As shown in FIG. 2, the supporting device 20 can be emplaced in the groove 90 when closed.

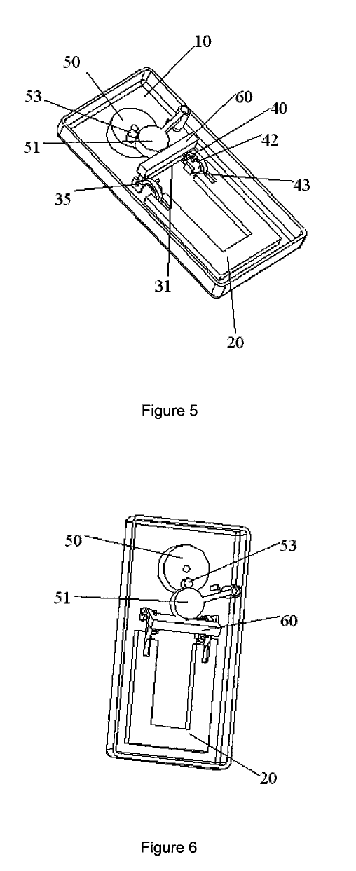

The rotatable connection between the main body 10 and the supporting device 20 can employ many methods, for example, hole shaft, hinge, etc. FIG. 3 and FIG. 4 show one embodiment of the present invention, wherein it employs a chute and a rotating shaft. According to this embodiment, the portable electronics further comprises a chute (not shown) and a rotating shaft 31, wherein said chute is located in a first of the main body 10 and the supporting device 20. The rotating shaft 31 is located inside the chute, and rotatably fits the chute, and said rotating shaft is connected to a second of the main body and the supporting device. As shown in FIG. 3 and FIG. 4, the chute is set in the main body 10 and the rotating shaft is set in the supporting device 20. The chute can also be set in the supporting device 20 and the rotating shaft 31 be set in the main body 10. The chute can be an open groove, such that it will be convenient to remove the rotating shaft 31 from the chute.

The automatic opening device of the present invention can be achieved by many methods. The following description will introduce various embodiments of the automatic opening device.

The first embodiment of the automatic opening device is to use an elastic component to achieve automatic opening. The elastic component can be various, for example, spring, spring leaf, etc.

The automatic opening device comprises one or more springs, both ends of a spring are fixed to the main body 10 and the supporting device 20, respectively, or the spring is compacted between the main body 10 and the supporting device 20; in which an elastic force of the spring is used to automatically flick the supporting device 20 to a position. In addition, because the spring itself has an intermediate stable state, when the spring keeps in the intermediate stable state, the supporting device 20 can hold the position at this moment. In another word, in this embodiment, the above mentioned caging devices are not required to keep the electronics standing steadily. The number of said springs can be one or more. FIGS. 3 and 4 show the examples of using two springs.

Said spring may be a torsion spring, a compression spring or a shrapnel spring. The springs in FIG. 3 and FIG. 4 are torsion springs. According to the embodiment shown in FIG. 3 and FIG. 4, said torsion spring 40 is put onto the rotating shaft 31, and the front foot and the rear foot are separately connected to or withstood the main body 10 and the supporting device 20, respectively, so that the supporting device 20 will take the rotating shaft as a central shaft to rotatably flick to an angle when subjected to the elastic force.

In some embodiment, the automatic opening device can further comprise a clamping component of the supporting device, such as a spring block button or a stent clamp to clamp the supporting device 20 when closed. The spring block button can be set in the groove 90, or be placed on the supporting device 20. When the supporting device 20 closes, it will be clamped in the groove 90 by the spring block button to prevent the supporting device 20 from opening. And when moving the spring block button, the supporting device 20 will be loosened, i.e., the supporting device 20 is automatically flicked under the elastic force of the spring 40.

The stent clamp is also applicable to the some embodiment when the supporting device 20 is a hollow stent. The stent clamp can be set in the groove 90. When the supporting device 20 closes, the hollow stent will be clamped by the stent clamp. Also, when pushing the supporting device 20 by hand to make the hollow stent away from the stent clamp, the supporting device 20 will be automatically flicked under the elastic force of the spring 40.

The second embodiment of the automatic opening device is to use an electric drive component to achieve automatic opening. The electric drive component can be various, for example, engine, motor, etc. And the supporting device 20 will be automatically opened by the electric drive component.

Said automatic opening device can be achieved to open automatically by the electric drive component and a transmission device. The transmission device can be a gear transmission; wherein the driving gear is driven to rotate by the engine and engages with the driven gear installed in the supporting device, thus to open the supporting device. Said transmission device can be other devices known by ones skilled in the art.

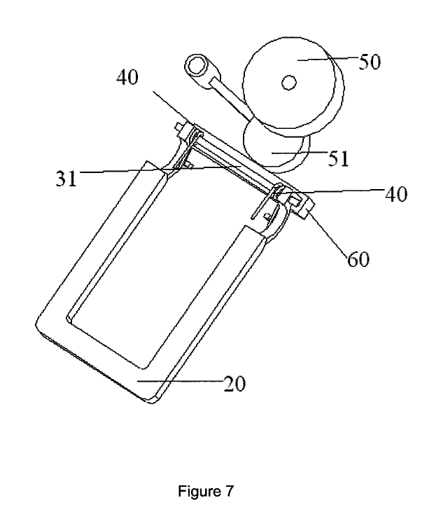

FIGS. 5, 6 and 7 show one embodiment. According to this embodiment, said automatic opening device further comprises a motor 50, a transmission device and a motor control device. The motor 50 is mechanically connected to the transmission device; the transmission device is mechanically connected to the supporting device 20; and the motor control device is electrically connected to the motor 50. Wherein, said motor 50 has a rotary table having a disc surface; said transmission device further comprises a runner 51 having a first side flange and a second side flange, a connecting rod 60 and a torsion spring 40; the disc surface of the rotary table of said motor 50 has a shift lever 53; the first side flange of the runner 51b is engaged with the shift lever 53, and the second side flange of the runner 51 is engaged with the connecting rod 60; said connecting rod 60 is fixed on an end of said supporting device 20 that is connected to the main body 10; said torsion spring 40 is attached to said rotating shaft 31, both ends of said torsion spring 40 are contacted with the main body 10 and the supporting device 20, respectively, and the torsion spring 40 is configured to be in a compressed state.

When said motor 50 starts to rotate, said runner 51 moves downwards driven by the shift lever 53, and the runner 51 pushes the connecting rod 60 to move downwards. Because the connection between the connecting rod 60 and the supporting device 20 is fixed at an angle, the connecting rod 60 pushes the supporting device 20 to rotate, and thus makes the supporting device 20 open.

The motor control device controls the motor 50 to start and stop. To open the supporting device 20, the motor control device starts the motor 50 to rotate from the initial position. The shift lever 53 of the motor 50 pushes the runner 51, and pushes the connecting rod 60 to move downwards, then drives the supporting device 20 to open. Furthermore, the motor control device controls the motor 50 to stop, which makes the supporting device 20 open to an angle, such that the supporting device 20 of the portable electronics can be opened automatically. When the shift lever 53 rotates to a lowest position, the motor control device stops the rotating of the motor 50. At this moment, the supporting device 20 is opened to a maximum angle and holds this position. When the motor control device further controls the motor 50 to continue rotating, the shift lever 53 of the motor 50 is away from the lowest position, and the supporting device 20 tends to close under the action of the elastic force of the torsion spring 40. When the motor 50 goes back to the initial position to achieve reduction, said supporting device 20 and the connecting rod 60 push the runner 51 to reduce, and an action cycle is finished.

The above mentioned motor control device can employ a controlling circuit, or an internal software of the portable electronics. Designing the software procedure can make the motor stop and start in different positions, such that to open the supporting device to different angles according to the users' needs or to open only at a fixed angle can be achieved.

The third embodiment of the automatic opening device is to employ a magnetic component to achieve automatic opening. The magnetic component can be various, such as magnet, electromagnet, etc.

According to one embodiment, the automatic opening device includes a pair of magnets, set in the corresponding positions of the main body 10 and the supporting device 20, respectively, wherein at least one of the magnets has configurable dipoles. When the poles of the opposite sides of the pair magnets are different, the main body 10 and the supporting device 20 exclude mutually, so as to open automatically. And when the poles of the opposite sides are same, the main body 10 and the supporting device 20 attract mutually, so as to close automatically.

The poles of one of the above pair of magnets installed in the main body 10 and the supporting device 20 are non-variable, and only the poles of the other magnet can be controlled to change; or the poles of both magnets are variable, and the poles of both magnets can be controlled to change.

In some embodiment, the magnet set on the main body is an electromagnet having one or more coils, which is convenient to change the current direction of the electromagnet coils, and thus to change the poles of the electromagnet. In this embodiment, the automatic opening device further includes a magnetism controller, which is electrically connected to the coils of said electromagnet to control the current direction of the electromagnet coils.

In some embodiment, to reduce the impact force on the main body 10 when opening and closing the supporting device 20, the repulsive force and the attractive force can be controlled by regulating the volume of the currents. Therefore, the magnetism controller can also be used to control the volume of the current of the electromagnet coils.

The above mentioned magnetism controller can be implemented by application programs of the portable electronics.

The portable electronics of the present invention can be used in mobile phone, PDA, digital player like MP3 and MP4, game player, electronic dictionary, flat-plate laptop computer, etc.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

What is claimed is:

1. A portable electronics, comprising:
a main body;
a supporting device being rotatably connected to the main body; and
an automatic opening device,
wherein the automatic opening device is configured to cause the supporting device to automatically rotate relative to the main body to a position so as to form an angle between the supporting device and the main body.

2. The portable electronics according to claim 1, wherein the range of the formed angle is 30 degree to 90 degree.

3. The portable electronics according to claim 1, wherein the supporting device further includes one or more supporting slabs or hollow stents.

4. The portable electronics according to claim 1, wherein the main body further includes a groove to emplace the supporting device, and the groove is configured such that its size and shape match the size and shape of the supporting device.

5. The portable electronics according to claim 1, wherein the automatic opening device further includes one or more springs, wherein both ends of the springs are fixed on the main body and the supporting device, respectively.

6. The portable electronics according to claim 1, wherein the automatic opening device further includes one or more springs, wherein the springs is compacted between the main body and the supporting device.

7. The portable electronics according to claim 6, wherein at least one of the springs is one selected from the group consisting of a torsion spring, a compression spring and a shrapnel spring.

8. The portable electronics according to claim 1, further comprising:
a chute; and
a rotating shaft;
wherein:
the chute is located in a first of the main body and the supporting device;
the rotating shaft is located inside the chute and rotatably fits the chute; and
the rotating shaft is connected to a second of the main body and the supporting device.

9. The portable electronics according to claim 8, wherein the automatic opening device further includes:
a motor,
a transmission device; and
a motor control device, wherein
the motor is mechanically connected to the transmission device;
the transmission device is mechanically connected to the supporting device and
the motor control device is electrically connected to the motor.

10. The portable electronics according to claim 9, wherein:
the motor further includes a rotary table having a disc surface, the disc surface of the rotary table having a shift lever;
the transmission device further includes:
a runner having a first side flange and a second side flange;
a connecting rod; and
a torsion spring,
wherein
the first side flange of the runner is engaged with the shift lever, and the second side flange of the runner is engaged with the connecting rod;
the connecting rod is fixed on an end of the supporting device that is connected to the main body; and
the torsion spring is attached to the rotating shaft and both ends of the torsion spring are contacted with the main body and the supporting device, respectively; and the torsion spring is configured to be in a compressed state.

11. The portable electronics according to claim 1, wherein the automatic opening device further includes a pair of magnets set in the corresponding positions of the main body and the supporting device, respectively, wherein at least one of the magnets has configurable dipoles.

12. The portable electronics according to claim 11 wherein,
the magnet set on the main body is an electromagnet having one or more coils; and
the automatic opening device further includes a magnetic controller electrically connected to the coils of the electromagnet.
